(19) United States
(12) Patent Application Publication
(10) Pub. No.: US 2024/0317190 A1
(43) Pub. Date: Sep. 26, 2024

(54) MECHANICAL ENERGY STORAGE SPEED CHANGE METHOD AND DEVICE

(71) Applicant: Yue Zheng, Shoreline, WA (US)

(72) Inventor: Yue Zheng, Shoreline, WA (US)

(21) Appl. No.: 18/614,746

(22) Filed: Mar. 25, 2024

Related U.S. Application Data
(60) Provisional application No. 63/454,701, filed on Mar. 26, 2023.

(51) Int. Cl. B60T 1/10

(52) U.S. Cl. CPC B60T 1/10

(57) ABSTRACT

A mechanical continuously variable transmission (CVT) that can store energy in mechanical form simultaneously, so that the vehicle kinetic energy during the last braking can be used for the next starting acceleration, obtaining unexpected energy-saving effects.

This application claims priority to U.S. Provisional Application No. 63/454,701, filed on Mar. 26, 2023, which is incorporated by reference herein in its entirety.

This is an invention about mechanical stepless transmission with energy storage function, which belongs to the intersection of transmission device and energy storage, and green energy, including electric vehicles and wind power generation.

### BACKGROUND

The application relates to improvements to flywheel energy storage and the stepless speed change technology. The inventor's previous U.S. Pat. Nos. 4,872,536, 4,932,504, 5,161,961, 5,232,412, 5,489,244 and corresponding European patents, Chinese Patent Nos. 90104953, 94104707.5, 93115309.3, 95100201.5, 98100836.4, 98100837.2, and 200510006947.4 provide background on the field of the invention. The mechanical continuously variable transmission (CVT) of this application can store energy in mechanical form simultaneously, so that the vehicle kinetic energy during the last braking can be used for the next starting acceleration, obtaining unexpected energy-saving technical effects, making significant improvements to the CVT technology in the above-mentioned patents.

The current braking energy storage of electric vehicles uses the motor to charge the battery during deceleration. Therefore, during the short deceleration and braking time, only about 10% of the kinetic energy can be charged into the battery and converted into electrochemical energy. Most of the kinetic energy is wasted. This invention uses a mechanical shaft to directly increase the speed to drive the input end of the transmission to rotate at high speed, which can store almost all the kinetic energy on the shaft in a mechanical form, thereby achieving the braking energy storage effect. At the same time, the transmission also provides sufficient braking torque to the vehicle, so that the vehicle can obtain excellent friction-free braking effect.

The current flywheel battery technology uses an electric motor to drive a flywheel to rotate at high speed and store electrical energy as kinetic energy. When releasing energy, the flywheel is used as a rotor to drive a motor in the form of a generator to release electrical energy. There is no direct mechanical connection between them. When this method is used in electric vehicles, it needs to go through two electrical energy-to-electrical energy conversions, which has low efficiency, high cost, complicated mechanism, large weight and volume, and is difficult to implement. The mechanical transmission of the present application is directly driven in a mechanical manner and directly stores the kinetic energy of the vehicle as the kinetic energy of the transmission. Therefore, it is very efficient. The steel used in the transmission replaces the non-ferrous metals used in the motor. It does not require a vacuum. The structure is simple and easy to manufacture. The cost is much lower than the current flywheel battery, only about 40% of the current hydromechanical transmission used in internal combustion engine vehicles.

### SUMMARY

The application contemplates a method of mechanically storing energy and saving energy in a transmission, the method comprising: when the transmission is in working condition, mechanically storing the kinetic energy in the transmission when changing speed while simultaneously obtaining braking torque; and when the transmission is in acceleration, releasing stored kinetic energy simultaneously while changing speed, thereby achieving energy storage and saving in the transmission.

In some embodiments of the method contemplated herein, the transmission comprises at least two planetary friction wheels 31 evenly distributed around the axis of the input shaft 1 and with varying outer diameters. In some embodiments, its two ends are supported in the slide grooves of the planet carriers 13 and 14 through planetary bearings and slider bearing seats 133 and 143 that can slide in the slide grooves of the planet carrier. In some embodiments, its axis is parallel or non-parallel to the axis of input shaft 1; the planetary friction wheel 31 can rely on the centrifugal force generated when the input shaft 1 rotates to move along the radial direction of the input shaft 1, thereby contacting and rubbing with the fixed friction wheel 2 and the rotatable friction wheel 4, obtaining power output on the rotatable friction wheel 4. In some embodiments, axial movement of the fixed friction wheel 2 and/or the rotatable friction wheel 4 can change the planetary friction wheel contact radius R1 and/or R3, thereby changing the gear ratio of the transmission. In some embodiments, the rotatable friction wheel 4 at the output end reversely drives the input shaft 1 at the input end to obtain braking torque, and at the same time increases the rotation speed of the input rotation system including the limit plate and small flywheel 134, thereby storing the kinetic energy in the revolution of the input rotation system and the rotation of the planetary friction wheel 31. In some embodiments, under the acceleration mode of the transmission, the fixed friction wheel 2 and/or the rotatable friction wheel 4 are moved axially to change the transmission ratio from large to small, thereby using the kinetic energy stored in the input rotation system for output.

The application provides an energy-storage transmission, comprising at least two planetary friction wheels 31 evenly distributed around the axis of the input shaft 1 and with varying outer diameters. In some embodiments, its two ends are supported in the slide grooves of the planet carriers 13 and 14 through the planet bearings and slider bearing seats 133 and 143. In some embodiments, its axis is parallel or non-parallel to the axis of input shaft 1. In some embodiments, the planetary friction wheel 31 can rely on the centrifugal force generated when the input shaft 1 rotates to move along the radial direction of the input shaft 1, thereby contacting and rubbing with the fixed friction wheel 2 and the rotatable friction wheel 4, obtaining power output on the rotatable friction wheel 4. In some embodiments, the distance from the contact point of the planetary friction wheel 31 and the fixed friction wheel 2 to the axis of the planetary friction wheel is the contact radius R1, and the distance from the contact point to the axis of the input shaft 1 is the fixed friction wheel contact radius R2, the distance from the contact point of the planetary friction wheel 31 and the rotatable friction wheel 4 to the axis of the planetary friction wheel is the contact radius R3, and the distance from the contact point to the axis of the input shaft 1 is the contact radius R4 of the rotatable friction wheel; the transmission ratio I=input shaft speed/rotatable friction wheel speed=1/(1−R2R3/(R1R4)); when the transmission ratio is negative, the transmission is in reverse gear, axial movement of the fixed friction wheel 2 and/or the rotatable friction wheel 4 can change the planetary friction wheel contact radius R1 and/or R3, thereby continuously changing the transmission ratio of the transmission. In some embodiments, the rotatable friction wheel 4 at the output end obtains braking torque when counter-driving the input shaft 1 at the input end, and at the same time increases the rotation speed of the input rotation system including the limit plate and small flywheel 134, thereby storing kinetic energy in the revolution of the input rotation system and the rotation of the planetary friction wheel 31. In some embodiments, in the acceleration mode of the transmission, the fixed friction wheel 2 and/or the rotatable friction wheel 4 are axially moved, changing the transmission ratio from large to small, thereby using the kinetic energy stored in the input rotation system for output acceleration.

In some embodiments of the energy-storage transmission, a radial chute is provided in the planet carrier, and the radial chute is equipped with slide block bearing seats 133 and 143 that can slide in the radial chute along the radial direction. In some embodiments, the inner cylindrical surface of the slider bearing seat is equipped with outer cylindrical bearing sleeves 131 and 141 that can rotate within it, and the outer cylindrical bearing sleeve is equipped with planetary bearings that are ribless cylindrical roller bearings or other types of bearings that allow axial slip, thereby preventing the axial component of the contact force on the planetary friction wheel from passing through the planetary bearing, so that the planetary friction wheel is constrained in the radial and axial directions by contact with the fixed friction wheel 2 and the rotatable friction wheel 4 under variable speed conditions. In some embodiments, the planet carrier, slider bearing seat, outer cylindrical bearing sleeve, ribless planetary bearing and planetary friction wheel constitute a subsystem; wherein multiple such subsystems are uniformly distributed around the input shaft axis, wherein each subsystem is consistent in size and weight to obtain equal centrifugal force and automatic load sharing.

In some embodiments of the energy-storage transmission, the rotatable friction wheel 4 and the fixed friction wheel 2 are made into smooth concave envelope curved surfaces near the contact points between the convex planetary friction wheel 31 and the rotatable friction wheel 4 and the fixed friction wheel 2; the absolute value of its curvature in each direction is slightly smaller than the absolute value of the curvature near the contact point of the corresponding planetary friction wheel 31, thereby obtaining an inner contact with a smaller difference in curvature in each direction of the planetary friction wheel. In some embodiments, when the shape of the planetary friction wheel 31 is concave, the curved surfaces of the rotatable friction wheel 4 and the fixed friction wheel 2 near the contact point are convex, wherein the absolute value of the curvature in each direction is slightly larger than the absolute value of the corresponding curvature of the planetary friction wheel to obtain a smaller internal contact curvature difference between the concave and convex mating surfaces, thereby improving contact strength and transmission efficiency. In some embodiments, the friction pair can be made of high contact strength materials such as cermet materials and carbon fiber reinforced ceramics materials that improve friction wheel contact strength.

In some embodiments of the energy-storage transmission, the planetary friction wheel 31 has a neutral groove C30, so that when the fixed friction wheel 2 is pushed to the position corresponding to the groove, it cooperates with the limit baffles 134 and 144 to limit the floating of the slider bearing seat, allowing the fixed friction wheel 2 to disengage from the planetary friction wheel 31, and the transmission is in neutral. In some embodiments, the neutral slot avoids the contact position where the transmission ratio tends to infinity. In some embodiments, the rotatable friction wheel 4 can move axially so that it is out of contact with the planetary friction wheel 31 and forms a neutral position.

In some embodiments of the energy-storage transmission, the energy-storage transmission comprises an output gear 6 that can slide along the axial direction, where an inner cone 65 is coaxially formed in the output gear 6 such that when the gear is directly shifted, the outer cone 15 is coaxially formed at the end of the input shaft 1 and engages in a conical manner. In some embodiments, the output gear 6 and a passive output gear 64 are a pair of helical gear meshing pairs with a helical angle. In some embodiments, the direction of the meshing axial force of the helical gear pair points to pushing the output gear 6 toward the input end, making the inner cone 65 and the outer cone 15 compress such that the friction torque obtained is always greater than the transmitted torque. In some embodiments, during decelerating and braking, the rotation speed of the passive output gear 64 exceeds the output gear 6 to drive the output gear 6, the direction of the meshing axial force of the output gear 6 is reversed, the output gear 6 is pulled away from the outer cone 15 in the axial direction, the direct gear is automatically disengaged, and the output end of the rotatable friction wheel 4 is disengaged from the output gear 6. In some embodiments, when reducing the internal combustion engine throttle or the speed of the electric motor such that the input speed of the transmission is lower than the output speed and the meshing axial force of the output gear pair 6 and 64 pulls the inner cone 65 away from the outer cone 15, the output gear 6 is in a neutral position with the external spline sleeve 42 facing the empty slot 62 and is conducive to vehicle sliding. In some embodiments, when the outer cone 15 is separated from the inner vertebra 65, and the output end of the rotatable friction wheel 4 is engaged with the output gear 6, the transmission is in a shifting condition with a transmission ratio greater than 1, when the output end of the rotatable friction wheel 4 is also disengaged from the output gear 6, the transmission is in neutral.

In some embodiments of the energy-storage transmission, the transmission is used in electric vehicles, and the starting acceleration process mainly relies on the energy storage release of the transmission energy storage rotation system of the present invention. In some embodiments, the battery loading capacity is significantly reduced compared to the current level. In some embodiments, the supply voltage is increased to reduce the discharge current. In some embodiments, the electric vehicle uses commutator-less DC motors to eliminate the inverter link from DC to AC and the variable frequency speed regulation link, reducing the cost of the vehicle.

The application contemplates an electric vehicle that uses the energy-storage transmission and/or the method of mechanically storing energy and saving energy in a transmission disclosed in the application.

In some embodiments of the energy-storage transmission, the transmission is used for internal combustion engine vehicles, and the transmission input shaft 1 is directly connected to the crankshaft of the internal combustion engine. In some embodiments, the input rotation system of the transmission functions as a flywheel in an internal combustion engine and a separate flywheel is omitted. In some embodiments, the transmission releases stored energy to drive to provide several times the acceleration power of the engine in a few seconds. In some embodiments, the reserve power of the engine is reduced or eliminated. This opens new design space for engine cost reduction and energy saving.

The application contemplates an internal combustion engine vehicle that uses the energy-storage transmission and/or the method of mechanically storing energy and saving energy in a transmission disclosed in the application.

In some embodiments of the energy-storage transmission, the transmission provides braking torque during deceleration, which is equivalent to a frictionless brake. This allows the traditional friction brake to be simplified, reducing the cost of the braking system and improving braking reliability.

In some embodiments of the energy-storage transmission, the transmission is driven by an electric motor and changes the gear ratio of the transmission to give a wide output speed range from deceleration to acceleration. In some embodiments, the transmission replaces frequency converters and/or motor soft starters. In some embodiments, the flywheel energy storage function of the transmission is controlled by the controller to store energy at low loads and release energy at peak loads, thereby flattening the peaks and troughs caused by short-term load changes, avoiding harmonic damage and energy consumption of the frequency converter, and protecting the power grid.

In some embodiments of the energy-storage transmission, the planetary friction wheel is made into a stepped cylindrical friction wheel, and the cylindrical diameters of each step are different. In some embodiments, the axis of the planetary friction wheel is parallel to the axis of the input shaft 1. In some embodiments, the fixed friction wheel and the rotatable friction wheel are made into cylindrical shapes to make the contact between the planetary friction wheel, the fixed friction wheel and the rotatable friction wheel be line contact. In some embodiments, the axial sliding fixed friction wheel and/or the rotatable friction wheel can change the diameter of the stepped cylinder in contact between the planetary friction wheel and the fixed friction wheel and/or the rotatable friction wheel, thereby changing the gear ratio of the transmission step by step.

In some embodiments of the energy-storage transmission, the transmission is simplified to a very small ratio gear reducer, the motor is a 4-pole asynchronous motor, the reduction ratios of gear reduction are 1.5, 2, 3, and 4 respectively, replacing 6-pole, 8-pole, 12-pole and 16-pole motors respectively. In some embodiments, the efficiency loss of the gear reducer is less than the efficiency loss increased by increasing the number of poles of the original AC motor to achieve the same output torque. In some embodiments, the added weight of the gear reducer is less than the weight added by increasing the number of poles of the motor. In some embodiments, energy efficiency is improved. In some embodiments, the use of non-ferrous metals in the motor is reduced.

In some embodiments of the energy-storage transmission, the transmission is used in wind turbines and the transmission is driven by the wind turbine through gear transmission. In some embodiments, when it works in the speed-increasing condition, the input shaft 1 of the transmission is connected to the generator. In some embodiments, when the wind turbine speed changes due to wind changes, the transmission is controlled to change the speed-up ratio continuously and accurately, so that the mechanical speed obtained by the generator accurately meets the same voltage, same frequency and same phase requirements of the wind turbine connected to the power grid. In some embodiments, the transmission relies on the mechanical energy storage function of the transmission of the present invention. In some embodiments, the transmission absorbs and stores energy when the wind is strong and releases energy when the wind is weak. In some embodiments, when coupled with transmission ratio control, the transmission replaces the current wind power grid-connected high-power power regulation system, greatly reducing the cost of wind turbines. In some embodiments, the transmission can completely eliminate the harmonic damage caused by the frequency converter inverter to the power grid. In some embodiments, when the wind speed is very low, the speed increase ratio of the transmission is increased so that the generator can still generate electricity and improve the utilization rate of wind energy.

The application contemplates a wind turbine that uses the energy-storage transmission and/or the method of mechanically storing energy and saving energy in a transmission disclosed in the application.

In some embodiments of the energy-storage transmission, the transmission is used to form a mechanical flywheel-battery hybrid energy storage vehicle with a mechanical charging system. In some embodiments, carbon fiber winding is used to strengthen the limiting plate and small flywheel 134. In some embodiments, the mass of the flywheel is increased. In some embodiments, the flywheel energy storage includes the revolution energy storage of the entire input rotation system, the rotation energy storage of the planetary friction wheel 31 and the rotation energy storage of the motor rotor. In some embodiments, when mechanically charging, the mechanical charging shaft of the charging pile installed on the roadside is mechanically connected to the external port of the mechanical charging shaft of the vehicle. In some embodiments, the roadside charging pile/charging pile uses mechanical direct drive to complete the mechanical charging of the vehicle in a short time of tens of seconds to minutes. In some embodiments, during a longer period of time when the vehicle is traveling using flywheel energy storage, the electric motor can charge the battery pack in generator mode. In some embodiments, the mechanical flywheel-battery hybrid energy storage vehicle also has a system that uses mains power to slowly charge the battery pack in the garage. In some embodiments, the electric motor can also mechanically charge the above-mentioned flywheel system of the vehicle for a long period of time at the same time, that is, the electric motor can slowly increase the speed of the transmission input rotation system through the electric motor, until it reaches the rated speed full of mechanical flywheel energy.

The application contemplates a mechanical flywheel-battery hybrid energy storage vehicle that uses the energy-storage transmission and/or the method of mechanically storing energy and saving energy in a transmission disclosed in the application. In some embodiments, when mechanically charging, the mechanical charging shaft of the vehicle is mechanically connected to the motor shaft or to the movable friction wheel 4 of the transmission. At this time, the transmission should be placed in neutral.

The application contemplates a roadside charging pile for mechanically charging the mechanical flywheel-battery hybrid energy storage vehicle of the present invention. In some embodiments, the energy storage transmission of the present invention driven by a motor is also installed in the charging pile to change the rotation speed of the mechanical charging shaft by changing the transmission ratio during charging. In general, the transmission ratio should be changed from large to small, so that the rotation speed of the mechanical charging shaft changes from low to high. In some embodiments, the flywheel energy storage system of the energy storage transmission in the charging pile releases energy when charging externally, and drives the motor to store energy in the flywheel system during the idle time when it is not charging.

In some embodiments of the roadside charging pile contemplated herein, the charging pile is equipped with a pair of ground rollers 73 and 74, whose peripheral linear speeds remain in the same direction and speed, and at least one of the rollers is driven by the energy storage transmission of the present invention driven by the above-mentioned electric motor installed in the charging pile. In some embodiments, when driving two rollers at the same time, the transmission output gear 6 can be meshed with two external gears of the same size that are coaxially connected to the rollers 73 and 74 respectively, so that the rollers 73 and 74 can rotate at the same speed and in the same direction. In some embodiments, when charging, the driving wheel 72 of the charged flywheel energy storage-battery energy storage hybrid electric vehicle 71 is supported on the rollers 73 and 74, the rollers 73 and 74 drive the driving wheels 72 to rotate and reversely drive the input shaft 1 through the vehicle's drive train and the transmission of the present invention until the high speed required for energy storage.

In some embodiments of the methods contemplated herein, the transmission comprises a continuously variable displacement hydraulic pump/motor. In some embodiments, the energy storage function of the transmission is completed by a hydraulic energy storage mechanism, optionally wherein the hydraulic energy storage mechanism is a hydraulic-air bag accumulator. In some embodiments, the output gear 6 is mechanically connected to the continuously variable pump/motor through the energy storage side clutch and is also directly connected to the electric motor or connected to the internal combustion engine through a conventional transmission. In some embodiments, the hydraulic port of the continuously variable pump/motor is connected to the hydraulic airbag accumulator and liquid storage tank through the reversible hydraulic valve. In some embodiments, when the vehicle decelerates or brakes, the output gear 6 drives the continuously variable pump/motor through the clutch, and through the connected hydraulic valve, high-pressure oil is injected into the hydraulic airbag accumulator to store energy, thus converting vehicle kinetic energy into hydraulic potential energy and simultaneously obtaining braking torque. In some embodiments, when the vehicle stops, the hydraulic valve closes and the continuously variable pump/motor becomes the parking brake. In some embodiments, when the vehicle starts to accelerate again, the hydraulic airbag accumulator releases the stored energy and the pressure decreases, and the reversible hydraulic valve is switched to the reverse direction so that the rotate direction of the gear motor that should be reversed is still the same as that of the gear pump during operation, thereby starting and accelerating the vehicle through the output gear 6. In some embodiments, when the hydraulic air bag accumulator is released, energy storage is complete, and the electric motor or internal combustion engine relay drives, the energy storage side clutch disengages, the electric motor of an electric vehicle relays the vehicle, or the transmission of an internal combustion engine vehicle engages and the internal combustion engine drives the vehicle.

In some embodiments of the methods contemplated herein, the transmission comprises a movable radial sealing block to continuously change the flow rate of the gear pump or gear motor, that is, it has a pump effect clutch. In some embodiments, when the vehicle starts working in motor mode, when the movable radial sealing block is controlled to move smoothly from the completely disengaged non-radial sealing position to the fully sealed position, the motor effect reaches the maximum from zero, allowing the vehicle to obtain the best starting acceleration capability. In some embodiments, when the vehicle decelerates and brakes, the movable radial sealing block is controlled to move smoothly from the completely disengaged non-radial sealing position to the fully sealed position, and the pump effect reaches the maximum from zero, allowing the vehicle to obtain the desired deceleration or optimal braking ability.

In some embodiments of the methods contemplated herein, the pair of gears that constitute the gear pump/motor are composed of the output gear 6 and the driven gear 64. At this time, the gear pair is in the liquid-tight sealing side plates on both sides. In some embodiments, when the vehicle is running normally, the reversible hydraulic valve is closed, the movable radial sealing block is in the completely disengaged position, the pump effect is zero, and the gear pair is idling in the oil, so the loss is very small.

### DETAILED DESCRIPTION

The present application includes a method for saving energy in a transmission through energy storage. It is characterized in that under braking conditions, kinetic energy can be mechanically stored in the transmission while the transmission is changing speed smoothly, and a braking torque can be provided. During acceleration, the transmission releases stored kinetic energy while shifting gears smoothly. At this time, the power given by the electric motor or internal combustion engine connected to the input end of the transmission, that is, the input power of the transmission, is less than the output power of the transmission, so that the transmission efficiency of the transmission calculated according to the traditional calculation method of transmission efficiency=output power/input power is greater than 1, achieving significant energy saving effects.

A key feature of the present application is to reverse drive the mechanical CVT when the vehicle is braking to temporarily, instantaneously, and mechanically storing the kinetic energy in the transmission, thereby obtaining braking force; when the vehicle starts again, the CVT releases kinetic energy to the output end at a very large reduction ratio, allowing it to start the vehicle at low speed. Also, the transmission ratio is smoothly reduced from extremely large to a suitable small transmission ratio, and the vehicle is driven to accelerate smoothly until driving at high speed. In urban road conditions with frequent braking and starting, the present application will greatly achieve energy-saving effects, and when used in electric vehicles, it can greatly increase the cruising range per charge and improve battery life.

In some embodiments, the transmission of the present disclosure has at least two planetary friction wheels evenly distributed around the central axis input shaft 1. These planetary friction wheels have an outer circular curved surface with a smooth change in outer diameter, referred to as planetary friction wheel 31, which can rely on the centrifugal force generated when the input shaft 1 rotates to move outward along the radial direction of the input shaft 1, thereby contacting and rubbing with the fixed friction wheel 2 and the rotatable friction wheel 4, and moving the fixed friction wheel 2 and/or the rotatable friction wheel axially. Wheel 4 can smoothly change the contact radius to continuously change the gear ratio of the transmission. When the vehicle decelerates, the transmission works in braking mode. The rotatable friction wheel 4 at the output end drives the input shaft 1 at the input end in reverse to obtain braking torque. At the same time, the speed of the input shaft 1 and the input rotation system that rotates with it is increased. The kinetic energy is stored in the revolving input rotation system and the planetary friction wheel 31 with rotation; the input rotation system consists of a high-speed rotating input shaft 1, at least two sets of planet carriers 13 and 14 evenly distributed around the input shaft, and slider bearing seats 133 and 143 that can slide freely in the chute of the planet carrier; the limiting plate is formed by the small flywheels 134 and 144 and the planetary friction wheel 31. At this time, the fixed friction wheel 2 and/or the rotatable friction wheel 4 move axially, under the limiting action of the limiting plates 134 and/or 144, the fixed friction wheel 2 and/or the rotatable friction wheel 4 are disengaged from the planetary friction wheel 31, the transmission is in the neutral position, and the input rotation system temporarily stores the kinetic energy in the form of a high-speed rotating flywheel. When the vehicle starts to accelerate again, the transmission works in acceleration mode, the fixed friction wheel 2 and/or the rotatable friction wheel 4 are disengaged from the planetary friction wheel 31, and the transmission is in the neutral position. The planetary friction wheel 31 contacts again and smoothly changes the transmission ratio from large to small, so that the kinetic energy stored in the input rotation system is output, and the vehicle starts and accelerates smoothly. The above part numbers are those used in the drawings.

### DESCRIPTION OF THE DRAWINGS

Further description will be given below in conjunction with the embodiments and accompanying figures.

FIG. 1 is an exemplary drawing of the device.

FIG. 2 is a partial sectional view of FIG. 1.

FIG. 3 is a schematic diagram of a charging pile composed of the device that can quickly charge a mechanical flywheel energy storage-battery hybrid energy storage vehicle.

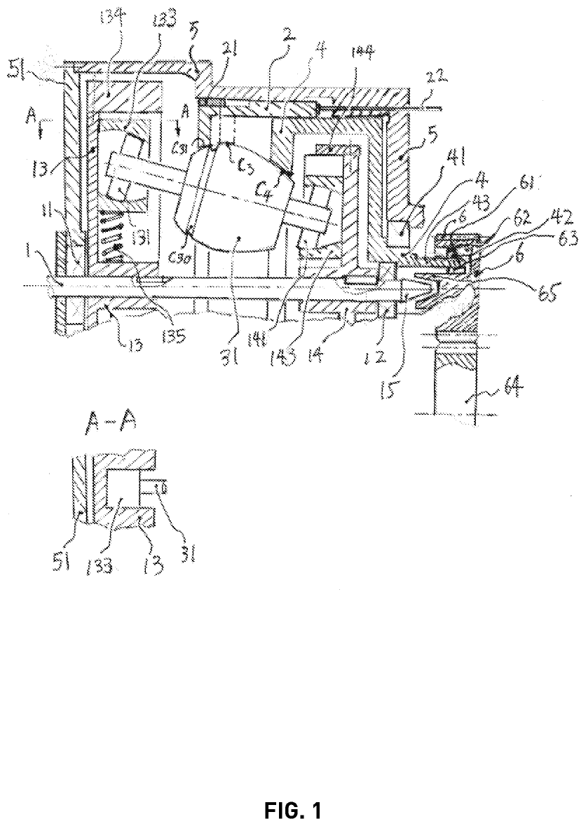

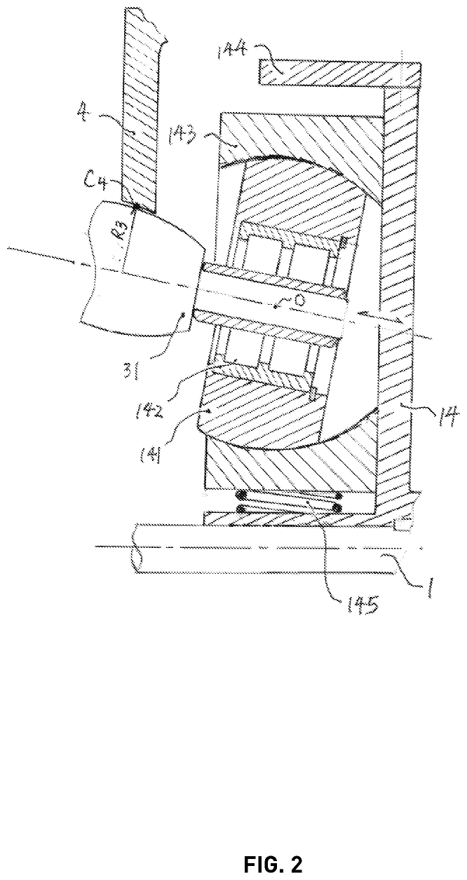

In FIG. 1, input shaft 1 is supported in machine cover 51 and rotatable friction wheel 4 respectively by bearing 11,12. The input shaft 1 is fixed with at least two planetary carriers 13 and 14 evenly distributed around the axis, radial chute is provided in the planetary carrier, and matching slider bearing seats 133 and 143 are installed in the radial chute (refer to the figure Partial sectional view A-A of 1), the slider bearing seat can slide radially in the radial chute, the inner cylindrical surface of the slider bearing seat is equipped with outer cylindrical bearing sleeves 131 and 141, and the outer cylindrical bearing sleeves 131 and 141. Because the outer cylindrical bearing sleeves 131 and 141 has an outer cylindrical surface that matches the inner cylindrical surface of the slider bearing seat (the center of which is O, see FIG. 2), it can rotate around point O in the slider bearing seat. The outer cylindrical bearing sleeve is equipped with planetary bearing, which can be cylindrical roller bearings without ribs or other types of bearings that allow axial slippage, such as 142 in FIG. 2. The bearing can be single-row roller bearings or double-row roller bearings, allowing the shaft of the planetary friction wheel 31 to slide axially in the ribless cylindrical roller bearing as shown by the arrow in FIG. 2. The planetary friction wheel is only constrained in the radial and axial directions due to contact with the fixed friction wheel 2 and the rotatable friction wheel 4 under variable speed conditions. Therefore, the axial component of the contact force on the planetary friction wheel can be prevented from passing through the planetary bearing, improving efficiency. The slider bearing seat at input end or one or more subsystems described below is uniformly distributed at equal angles around the input shaft axis. Such slider bearing seat at input end can be, for example, the symmetrically installed outer cylindrical bearing sleeves and ribless cylindrical roller bearings in 133. A subsystem may include the above-mentioned planet carrier, slider bearing seat, outer cylindrical bearing sleeve, ribless cylindrical roller bearing and planetary friction wheel; there can be multiple such subsystems. The composition of each subsystem should be consistent in size and weight to obtain equal centrifugal force, thus obtaining the invention's automatic load sharing function. Due to uniform distribution symmetry, the resultant centrifugal force of these subsystems is zero, forming multiple evenly distributed planetary friction wheels to increase the load capacity of point contact friction transmission, and the bearing load force is reduced due to balance. Known aspects in planetary transmission and are not described in detail.

To reduce the effect of centrifugal force on the bearing, the slider bearing seat and the outer cylindrical bearing sleeve can be made lighter. In some embodiments, they can be made of light materials such as aluminum alloy.

When the input shaft 1 is driven to rotate by the electric motor or internal combustion engine, the planetary friction wheel system is driven by centrifugal force to rise away from the input shaft. That is, the slider bearing seat rises outward in the radial slide groove of the planet carrier, forcing the planetary friction wheel to contact the fixed friction wheel 2 and the rotatable friction wheel 4, while being constrained in the radial and axial directions. The fixed friction wheel 2 is supported in the inner cylindrical surface of the housing 5 and is constrained by the feather key 21 so that it cannot rotate and can only slide along the axial direction; its axial sliding is controlled by the joystick 22 fixed to it. The rotatable friction wheel 4 is supported in the inner cylindrical surface of the housing 5, and can also be supported in the inner cylindrical surface of the fixed friction wheel 2; its right end is the output end and can be supported in the housing 5 through the bearing 41. The bearing 41 generally plays an axial positioning role. When the rotatable friction wheel 4 needs to slide axially, the bearing 41 can also be a ribless roller bearing that allows axial sliding. When the input shaft speed increases, the centrifugal force of the planetary friction wheel system increases, the contact positive pressure between the planetary friction wheel, the fixed friction wheel, and the rotatable friction wheel increases, under the constraints of the fixed friction wheel, the friction traction force generated by the positive contact pressure drives the rotatable friction wheel 4 to rotate to obtain power output. In some embodiments, the axis of the planetary friction wheel 31 is not parallel to the axis of the input shaft 1. The contact radius of the planetary friction wheels are R1 and R3; the distance from the contact point C3 between the planetary friction wheel 31 and the fixed friction wheel 2 (the dotted line position in FIG. 1) to the axis of the planetary friction wheel 31 is the contact radius R1, the distance between the contact point C3 and the axis of the input shaft 1 is the fixed friction wheel contact radius R2, the distance from the contact point C4 of the planetary friction wheel 31 and the rotatable friction wheel 4 to the axis of the planetary friction wheel is the contact radius R3, and the distance between the contact point C4 and the axis of the input shaft 1 is the contact radius R4 of the rotatable friction wheel. The following can be derived: Transmission ratio I=input shaft speed N1/rotatable friction wheel speed N4=1/(1−R2R3/(R1R4)). When I is positive, the direction of the input shaft 1 rotation is the same as the direction of the output shaft, i.e., the output shaft of the rotatable friction wheel 4; when I is negative, the input shaft 1 and the output shaft rotate in opposite directions. Under normal circumstances, when the planetary friction wheel 31 and the fixed friction wheel 2 are in contact with the contact point C3, the rotation direction of the input shaft 1 is the same as the rotation direction of the rotatable friction wheel 4, and the transmission works in forward gear. When the planetary friction wheel 31 and the fixed friction wheel 2 (the solid line position in FIG. 1) contact the contact point C31, the rotation direction of the input shaft 1 is opposite to the rotation direction of the rotatable friction wheel 4, and the transmission operates in reverse gear.

The planetary friction wheel 31 has a neutral groove C30, so that when the fixed friction wheel 2 is pushed to the position corresponding to the groove, it cooperates with the limit baffles 134 and 144 to limit the floating of the slider bearing seat 133, causing the fixed friction wheel 2 to disengage from the planetary friction wheel 31, and the transmission is in the disengagement position (neutral). Neutral slot C30 also avoids the contact position where the transmission ratio approaches infinity. In conjunction with the limiting effect of the limiting baffles 134 and 144 on the floating of the slider bearing seat 133, the rotatable friction wheel 4 can also move axially so that it breaks away from contact with the planetary friction wheel 31 and forms a neutral position.

In some embodiments, in order to improve the load-bearing capacity and reduce the contact stress of the planetary friction wheel, the rotatable friction wheel 4 and the fixed friction wheel 2 can be made into smooth concave envelope curved surfaces near the contact points C4, C3, and C31 between the convex planetary friction wheel 31 and the rotatable friction wheel 4 and the fixed friction wheel 2, the absolute value of its curvature in each direction is slightly smaller than the absolute value of the curvature of the corresponding planetary friction wheel 31, so as to obtain the inner contact with the curved surface with a smaller difference in curvature of the planetary friction wheel 31, as shown in FIG. 2. In the same way, when the shape of the planetary friction wheel 31 is concave, the curved surfaces of the rotatable friction wheel 4 and the fixed friction wheel 2 near the contact point should be correspondingly convex, the absolute value of the curvature in each direction should be slightly larger than the absolute value of the corresponding curvature of the planetary friction wheel 31 to obtain a smaller internal contact curvature difference between the concave and convex matching surfaces.

To improve the contact strength of the friction wheel, the friction wheel of the present invention can be made of high contact strength materials such as cermet materials and carbon fiber reinforced ceramics materials.

In some embodiments, pressure springs 135 and 145 are placed at the bottom of the slider bearing seats 133 and 143 to establish an initial outward thrust for each slider bearing seat. This allows the planetary friction wheel 31 to slightly contact the fixed friction wheel 2 and the rotatable friction wheel 4 when stationary. When the input shaft speed is increased, the planetary friction wheel will not collide with the fixed friction wheel and the rotatable friction wheel due to excessive rise. It also enables the initial friction torque to be established when the transmission operates in the reverse driving mode of driving the input shaft 1 from the rotatable friction wheel 4, forming a positive feedback process such that the input shaft speed increases—greater centrifugal force—higher friction torque—the input shaft speed increases.

The transmission of the present invention has automatic compensation characteristics. After the planetary friction wheel, fixed friction wheel, and rotatable friction wheel wear, the automatic pressing effect of centrifugal force can well compensate for the wear. The result is a transmission with high reliability and extremely long fatigue life.

### EXAMPLES

The following examples are embodiments of the present inventions and not limiting to the scope of the invention.

### Example 1

When R1=60, R2=140, R3=25, R4=150, (in mm, the same below) then Transmission ratio I=1/(1−140*25/(60*150))=1.636.

When the control rod 22 fixedly connected to the fixed friction wheel 2 pushes and pulls the fixed friction wheel 2 to slide axially and/or allows the rotatable friction wheel 4 to slide axially, the contact radii change as follows:
R1=56.1, R2 32 141, R3=60, R4=151 , then
Transmission ratio I=1/(1−141*60/(56.1*151))=763

When R1=45, R2 is about 140, R3 is about 60, and R4 is about 151, the transmission ratio I is about −4.23;

When R2=140, R4=150, R1 is about 29.86, R3 is about 64, the transmission ratio is about −1.

When R2=140, R4=150, R1 is about 25, R3 is about 64, the transmission ratio is about −0.72, and the absolute value of the transmission ratio is less than 1, it indicates that the transmission is working in an increasing speed condition.

The negative sign of the transmission ratio indicates that the transmission ratio can be the reverse transmission ratio. At this time, the planetary friction wheel and the fixed friction wheel are usually in contact with the contact point C31 on the left side of the neutral slot C30. Thus, the continuously variable transmission of the present invention has an extremely wide speed change range.

A hollow tubular output flange 43 is formed on the output end of the rotatable friction wheel 4, in which the output gear 6 is supported by a ribless roller bearing or a needle bearing or other bearings 63 that allow axial slippage, the output gear 6 therefore can slide axially on the output flange 43, the output flange 43 is coaxially fixed with an external spline sleeve 42, and the output gear 6 is coaxially fixed with an internal spline sleeve 61 (filled black in FIG. 1). When the transmission is in the working condition, the outer spline sleeve 42 meshes with the inner spline sleeve 61 to transmit the power from the rotatable friction wheel to the output gear 6, and then through the engagement with the passive output gear 64, transmission of power to the passive output gear 64 and the differential-wheel half shaft of the vehicle connected thereto. When the control mechanism pushes the output gear 6 along the axis to slide to the left in FIG. 1, that is, the direction of the input end, the outer spline sleeve 42 is first disengaged from the inner spline sleeve 61 and enters into the hollow groove 62 formed in the output gear 6. position, power output cut off, transmission in neutral. When pushing the output gear 6 further to the left, that is, the direction of the input end, so that the inner cone 65 coaxially formed in the output gear 6 is engaged with the outer cone 15 tapered coaxially formed at the end of the input shaft, at this time, the input shaft 1 It is directly engaged with the output gear 6, and the transmission is in the direct gear position with transmission ratio=1. The output gear 6 and the driven output gear 64 are a pair of helical gear meshing pairs with a helical angle, and the direction of the meshing axial force of the helical gear pair is to move the output gear 6 to the left in FIG. 1 push the inner cone 65 and the outer cone 15 tightly, so that the obtained friction torque is always greater than the transmitted torque. During deceleration and braking, the rotation speed of the passive output gear 64 exceeds the output gear 6 and drives the output gear 6, causing the direction of the meshing axial force of the output gear 6 to reverse, the output gear 6 is pulled axially in the direction away from the outer cone 15, the direct gear is disengaged, and the transmission is in a speed change condition with a transmission ratio greater than 1, using reverse drive to increase the input speed to achieve energy storage and simultaneously providing braking torque to the vehicle. In this way, the helical gear meshing pair formed by the output gear 6 and the passive output gear 64, the inner cone 65 and the outer cone 15 together form a self-pressing automatic engagement/disengagement clutch.

When the vehicle is running at high speed on a smooth road with direct gear, if the throttle of the internal combustion engine or the speed of the electric motor is reduced, the relative rotation of the input speed lower than the output speed drives the meshing axial force of the output gear pair 6 and 64 to pull the output gear 6 to the right, the inner cone 65 can be disengaged from the outer cone 15, the output gear 6 is in the neutral position where the outer spline sleeve 42 faces the empty slot 62, and the vehicle slides.

When the vehicle decelerates and brakes, the transmission is in the working state of reverse drive and speed-up, and the vehicle power transmitted from the output gear 6 reverse-drives the transmission. The transmission is in a small transmission ratio first, and then smoothly increases the transmission ratio. The rotation speed of shaft 1 increases, and the reverse driving torque acting on the output gear 6 makes the vehicle obtain braking force, and the control lever 22 is pushed to increase the transmission ratio so that the vehicle obtains the braking force required for optimal deceleration. At the same time, the input rotation system is composed of the input shaft 1, the planet carrier 13 and 14, the limit baffle 134 and 144, the slider bearing seat 133 and 143, the outer cylindrical bearing sleeve 131 and 141, the ribless cylindrical roller bearing and the planetary friction wheel 31. As the speed increases, the input rotation system will increase with its moment of inertia, storing the kinetic energy of the vehicle at high speeds. When the process of vehicle deceleration braking-transmission energy storage is over, the fixed friction wheel 2 is pushed to the disengagement position corresponding to the neutral groove C30 of the planetary friction wheel, and the input rotation system maintains high-speed idling and energy storage with very low mechanical loss. When the green light at the intersection is on and the vehicle needs to start and accelerate again, the control lever 22 is pulled to have the fixed friction wheel break away from the neutral slot C30, and contact the planetary friction wheel 31 again, the transmission ratio decreases smoothly from large to small, and the input rotation system stores the kinetic energy of the vehicle which can be transmitted to the output gear 6 through the transmission to drive the vehicle to accelerate, and the acceleration process can be controlled by grasping the speed of the reduction of the transmission ratio until the energy storage of the input rotation system drives the vehicle to reach a certain speed, and then it is driven by the engine or electric motor relay.

Due to the transmission function of the present invention, when used for starting an electric vehicle, not only does the transmission's ability to amplify torque in a wide range allow smaller motor torques, which can significantly reduce the discharge current, but the energy storage release of the transmission can also reduce the discharge current. Thus, it is possible to match the characteristics of the motor and battery pack to achieve an overall optimized design, significantly reducing I\hat{ }2*R losses and improving overall machine efficiency. The braking energy storage-energy release acceleration function of the present invention can greatly improve the endurance of electric vehicles, while allowing the battery loading capacity to be reduced, reducing motor cost. Commutator-less DC motors can be used to eliminate the need for inverter links from DC to AC and variable frequency speed regulation links, significantly reducing the cost of the controller. Since the transmission assumes the main braking function, it can also significantly reduce the cost of the braking system and improve the reliability of the braking system. These factors significantly reduce vehicle costs.

### Example 2

Continued discussion of the important issues that must be solved to constitute practicality. A 4-ton car has a kinetic energy of 0.8 MJ at a speed of 72 km/h. It is not difficult for the transmission of the present invention to store this kinetic energy. For example, a 20-kilogram homogeneous disk with a peripheral material of high-strength maraging steel, an allowable peripheral linear speed of 500 meters/second, and a kinetic energy of about 1.25 MJ can completely store the kinetic energy of the above-mentioned car at a speed of 72 kilometers per hour. In the present invention, the input rotation system of the motor rotor plus the transmission of the invention is an energy storage rotation system, and its rotation mass is an energy storage rotation mass. The limiting baffle and small flywheel 134 in FIG. 1 can be made thicker, that is, the outer diameter is larger; the planetary friction wheel 31, the fixed friction wheel 2, the rotatable friction wheel 4, and the limit baffle and small flywheel can all be made of high-strength maraging steel, carbon fiber-reinforced ceramics, cermets and other high-strength materials and their composite materials, thus allowing peripheral linear speeds of more than 500 m/s. The rotational inertia radius of the input rotation system of the present invention is larger than that of the homogeneous disc. Therefore, it is conservative to estimate the energy storage capacity of the transmission of the present invention based on the above-mentioned homogeneous disc.

Friction drive must satisfy the maximum torque. Suppose half of the weight of the car in this embodiment acts on the driving wheel, with a coefficient of adhesion of 0.7, then the maximum adhesion force of the driving wheel is 2000 kilograms*0.7=14000N. Assuming the radius of the wheel is 0.25 meters, then the maximum torque o the driving wheel is 14000*0.25=3500NM. Assuming the fixed gear ratio of the output gear 6 to the passive gear 64 is 3, then the maximum output torque of the transmission=3500/3 =1167NM.

In this embodiment of the gearbox, there are four evenly distributed planet friction wheels 31. There are four corresponding subsystems consisting of the slide bearing seat, outer cylindrical bearing sleeve, non-grooved cylindrical roller bearing, and planet friction wheel, all evenly spaced at 90-degree intervals. The total weight of the four subsystems is 24 kilograms. The centrifugal force generated is divided equally between acting on the fixed friction wheel 2 and acting on the rotatable friction wheel 4. The radius of the equivalent mass point where the centrifugal force acts on the rotatable friction wheel is 0.1 meters. Therefore, at the input shaft speed or input speed N1=3300 rpm, the centrifugal force acting on the rotatable friction wheel, namely the frictional normal force, is approximately 143160N. When using traction oil/lubricating oil, the friction coefficient commonly falls within the range of 0.06-0.10. Taking a friction coefficient of 0.072, the frictional force obtained is 10300N. With a contact radius R4 of approximately 0.128 meters on the rotatable friction wheel 4, the output torque that can be obtained on the rotatable friction wheel 4 is approximately 1319NM. The output torque exceeds the maximum output torque determined by the adhesion force of 1167NM. In other words, as long as the input speed is higher than 3300 rpm, the maximum output torque can be guaranteed.

The minimum transmission ratio required for the maximum vehicle speed. When the vehicle speed is 240 kilometers per hour, the corresponding wheel speed is approximately 2550 rpm. In this embodiment, the fixed gear ratio is 3. When the required output speed of the transmission is approximately 7650 rpm, when the transmission is in direct gear, this speed is the same as the motor speed. When the high-speed motor speed reaches 15000 rpm, the required speed ratio of the transmission is approximately 2. When R1=60, R2=138, R3=30, R4=132 (units in millimeters), the transmission ratio of the gearbox is calculated as follows: I=1/(1−138*30/(60*132))=2.095. Therefore, the transmission ratio of the gearbox is approximately 2.095.

Regarding the maximum transmission ratio required for smooth starting: Assuming a starting vehicle speed of 1.2 kilometers per hour, equivalent to 0.33 meters per second, corresponding to a transmission output speed of 40 rpm. When the transmission input speed reaches the maximum torque requirement of 3300 rpm, the transmission ratio is calculated as 3300/40=82.5. When the transmission is in an energy storage state with a peripheral velocity of 500 meters per second, and the maximum diameter of the input rotating system is approximately 0.3 meters, which corresponds to the outer diameter of the limit plate and the flywheel 134, the input shaft 1 of the transmission rotates at approximately 31850 rpm, the maximum transmission ratio required for the transmission is 31850/40=796 (it can still be directly connected to the motor shaft as needed; for internal combustion engines, an automatic overrunning clutch can be used to disengage from the engine shaft when the transmission speed exceeds the engine speed. The overrunning clutch can utilize the inventor's principle of an unassisted automatic clutch based on the inclined surface, as described in the inventor's Chinese patent documents such as Patent No. 200510006947.4).

When R1=57.6, R2 is about 138, R3 is about 55, R4 is about 132, the transmission ratio of the transmission is about 576, when R1=57.53, the transmission ratio reaches 1918.

As discussed above, by operating the control lever 22, the transmission ratio of the transmission can continuously and smoothly change between the maximum transmission ratio 1918 and the minimum transmission ratio, so the vehicle can start and accelerate extremely smoothly. When the intersection light turns green, the vehicle transmission switches from neutral to forward gear with the largest transmission ratio, and smoothly and quickly transitions to the small transmission ratio, achieving a smooth and rapid ideal acceleration curve, until near the minimum transmission ratio, the vehicle speed is about 50-80 kilometers per hour, the energy storage is basically released, the electric motor increases the speed and drives the relay, accelerating the vehicle to the required high speed, and the transmission can be shifted into direct gear. The initial acceleration process mainly relies on the energy storage of the transmission energy storage rotation system of the present invention, which greatly reduces the battery discharge and is very effective in improving battery life and endurance. Storing the kinetic energy of the vehicle during braking for the next acceleration can also significantly save the energy consumption of internal combustion engine vehicles. For urban road conditions, it can save more than 30% of internal combustion engine fuel.

The control system of the transmission of the present invention can be implemented using currently known technologies, including using an electronic controller containing a microprocessor.

The transmission releasing energy storage drive of the present invention can provide acceleration power several times that of the engine in a few seconds, allowing the vehicle to achieve the world's shortest 0-100 Km/h acceleration time under adhesion restrictions without using a high-power engine. This allows the engine's reserve power to be reduced or even eliminated, opening up new design space for engine cost reduction and energy saving.

The transmission of the present invention provides braking torque during deceleration, which is equivalent to a frictionless brake, thereby allowing the traditional friction brake to be simplified, reducing the cost of the braking system and improving braking reliability.

For this embodiment, when R2 is approximately 138 mm, R3 is approximately 55 mm, and R4 is approximately 132 mm, then when RI is less than 57.4 mm, the transmission operates in reverse gear. The reverse gear shifting range can be smaller for ordinary vehicles, and larger for construction machinery and other vehicles.

The positive friction pressure of the transmission of the present invention comes from centrifugal force, unlike the artificially pressurized positive pressure of the current friction transmission that needs to pass through the bearings. Further, the contact axial force of the planetary friction wheel 31 does not pass through the planetary bearings, and there are multiple evenly distributed subsystems of the planetary friction wheel system, so the bearing load is small and the loss is extremely low. There is internal contact rolling friction with a small curvature difference between the planetary friction wheel 31, the fixed friction wheel 2, and the rotatable friction wheel 4, and its rolling friction loss is extremely small. The small curvature difference internal contact makes the sliding rate very small, so the transmission has extremely high mechanical transmission efficiency. It is easy to achieve 0.96-0.99 within the commonly used transmission ratio range. This can be calculated by known methods in the field.

It is known that flywheel batteries have high energy storage per unit weight, but the cost is still high. The high-efficiency continuously variable transmission with extremely wide speed range of the present invention can adapt to the extremely high speed of the energy storage rotation system with a huge transmission ratio at the very low speed at the end of vehicle braking and the beginning of starting. Therefore, the flywheel energy storage can be directly input and output mechanically and conveniently, which can greatly reduce the cost of the flywheel energy storage system when used for vehicle energy storage. Moreover, direct mechanical energy input and output is used instead of electrical energy input and output, eliminating the loss of the electrical energy-mechanical energy conversion link of the flywheel battery, and avoiding the problem of insufficient battery energy storage during braking and thus wasting energy. In the urban traffic conditions of “stop on red light, go on green light”, the parking time at the intersection is short and the energy storage consumption is very small. Therefore, there is no need to vacuum the inside of the motor and transmission, no need to use magnetic bearings, and no need to use large amounts of non-ferrous metals and carbon fibers, thus significantly reducing manufacturing costs.

### Example 3

When the present invention is used in an internal combustion engine vehicle, when the transmission input shaft 1 of the present invention is directly connected to the crankshaft, the input rotation system forms part of the rotational inertia of the internal combustion engine flywheel. Therefore, the mass of the flywheel can be reduced accordingly, so that the flywheel can be omitted.

### Example 4

When invention is used in wind turbines, the transmission is driven by the wind turbine through gear transmission and works in the speed-increasing condition. Usually, the shaft of the driven gear 64 should be directly connected to the wind turbine shaft, and the input shaft 1 of the transmission of the present invention is connected to the generator. In order to increase the gear ratio to obtain a higher transmission speed, the small tooth difference gear transmission described in U.S. Pat. No. 5,232,412 can be used for the speed transmission between the wind turbine shaft and the transmission. When the wind turbine speed changes due to wind changes, the microprocessor command control mechanism smoothly, continuously and accurately controls the transmission ratio of the transmission, that is, the speed-up ratio, so that the mechanical speed obtained by the generator accurately meets the requirements for the wind turbine to be integrated into the power grid, that is, the requirements of the same voltage, same frequency and same phase. The mechanical energy storage function of the present invention absorbs and stores energy when the wind is strong, and releases energy when the wind is weak. Cooperating with the transmission ratio control system, it is easier to meet the wind power grid connection requirements. Replacing electric power regulation with mechanical speed regulation can eliminate the current expensive high-power frequency conversion system and other wind power grid-connected regulation systems, greatly reducing the cost of wind turbines and significantly reduce the cost of wind power. It can also completely eliminate the harmonic damage to the power grid caused by the invert of frequency converter of the current grid-connected mechanism, and obtain pure sine wave AC power supply. Estimates show that when the gear speed-up mechanism uses the inventor's ZY super multi-tooth meshing gear mechanism with small tooth difference, the 1000 KW wind turbine uses the continuously variable transmission of the present invention, and when the wind speed is very low, the speed increase ratio of the transmission is increased so that the generator can still generate electricity, thereby improving the wind energy utilization rate, and the comprehensive effect can reduce the cost of wind power per kwh to less than half of the current level.

Generally, using an electric motor to drive the continuously variable transmission of the present invention can provide a wide output speed range from deceleration to speed up; loads adapted to the characteristics of fans, pumps and quadratic loads can replace frequency converters. Since the efficiency of the transmission of the present invention in the common transmission ratio range is higher than that of a frequency converter, the industrial production cost of the transmission can be lower than the cost of a frequency converter of the same power. Therefore, replacing the frequency converter can improve energy efficiency and reduce manufacturing consumption. It can eradicate the harmonic damage of the frequency converter and its adverse effects on the motor at low frequencies and low speeds. It can also amplify the torque of the motor, the flywheel energy storage function of the transmission can store energy at low loads under the control of the controller and release energy at peak loads, thereby flattening the peaks and troughs formed by short-term load changes. When the motor starts, the centrifugal force of the planetary friction wheel 31 of the transmission increases as the rotational speed increases, and the output torque also gradually forms as the rotational speed increases. This means even if the motor is started with full load, the starting current of the motor is very small, close to no-load starting, thus the motor has soft starting characteristics and can replace the soft starter of the motor. When encountering an impact load, the impact load will cause slipping between the planetary friction wheel, the fixed friction wheel 2 and the rotatable friction wheel 4. As a result, the motor has an automatic overload protection function and avoids the impact of starting and impact loads on the power grid. This is unachievable by an inverter/frequency converter.

For embodiments that do not require stepless speed change, the planetary friction wheel can be made into a stepped cylindrical friction wheel, with the cylindrical diameter of each step being different. The axis of the planetary friction wheel remains parallel to the axis of the input shaft 1. Correspondingly, the fixed friction wheel and the rotatable friction wheel are also made into cylindrical shapes, so that the contact between the planetary friction wheel and the fixed friction wheel and the rotatable friction wheel is line contact, the fixed friction wheel and/or the rotatable friction wheel slide along the axial direction, allowing the planetary friction wheel to rise or be pressed down under the action of centrifugal force, changing the diameter of the stepped cylinder in which the planetary friction wheel contacts the fixed friction wheel and/or the rotatable friction wheel, thereby changing the transmission ratio of the transmission in steps.

A way to further improve the energy efficiency of the motor, and also to further reduce the use of non-ferrous metals in the motor as mentioned above, is to rationally design the transmission to amplify the torque and thereby reduce the motor torque. At the expense of increasing the use of steel materials in the transmission, reducing the use of non-ferrous metals in the electric motor. A first-stage internal gear reduction can be used to replace the transmission connected behind the above-mentioned motor. It is known that the cost per kilogram of non-ferrous metals such as copper, aluminum and silicon steel sheets used in motors is several times that of steel. Therefore, the present invention proposes two design conditions to achieve new technical effects. One is to have the efficiency loss of the transmission be smaller than the efficiency loss increased by increasing the number of poles of the original AC motor to achieve the same output torque. For example, the efficiency of a 4-pole asynchronous motor is 0.96 and the efficiency of an 8-pole motor is 0.94. Then the efficiency loss of a transmission with a transmission ratio of 2 should be much less than 2%, preferably less than 1%. Second is to have the increased weight of the transmission be less than the increased weight of the motor by increasing the number of poles. In a simple case, one can just add one-stage gear reduction with extremely small transmission ratios of 1.5, 2, 3, and 4 behind the 4-pole asynchronous motor to replace the 6-pole, 8-pole, 12-pole, and 16-pole motors respectively. When this gear reducer uses some of the technical features described in U.S. Pat. No. 5,232,412, it can achieve the above two design conditions, forming a ZY clean motor and achieving technical effects that ordinary gear reduction motors cannot achieve. Taking a 30 kW AC asynchronous motor as an example, according to the highest energy efficiency standards NEMA Premium in the United States, using a ZY clean motor to replace the current 6-pole motor with a speed (referring to synchronous speed, the same below) of 1200-1000 rpm can increase the efficiency from the current standard of 0.953 to 0.9580-0.9585, saving 0.5%-0.55% of electricity; Replacing the 8-pole motor with a speed of 900 rpm-750 rpm can increase the efficiency from the current standard 0.942 to 0.9577-0.9580, saving 1.57%-1.6%; replacing the current low-speed motor or gear motor with a speed of 750 rpm-15 rpm, which can Improve the efficiency to 0.94-0.955, saving about 2%-4% of electricity. The weight and manufacturing cost of ZY clean motors are much lower than the current motors they replace. Taking the 30 KW specification as an example, in the speed range of 1200 rpm to 150 rpm, the weight of the ZY clean motor is not greater than the weight of the original 6-pole motor, or only ⅔ of the weight of the original 8-pole motor; and it does not use gear surface heat treatment to protect the environment and further save electricity.

### Example 5

The present invention can be used to form a mechanical flywheel-battery hybrid energy storage vehicle with a mechanical charging system. In such a vehicle, mechanical charging can be completed in a short time, from tens of seconds to minutes, by mechanically driving the charging port at the roadside charging pile/charging pile. Carbon fiber can be used to make the flywheel rim. For example, the limit plate and small flywheel 134 are strengthened by carbon fiber winding; its peripheral linear speed reaches 1000 meters/second, and its mass is increased to 300 kilograms. The flywheel energy storage of the transmission includes the rotational energy storage input to the rotation system, the rotation energy storage of the planetary friction wheel 31, and the rotation energy storage of the motor rotor, having a total mechanical flywheel energy storage capacity of 200 megajoules and approximately 55 kilowatt hours, which exceeds the battery energy storage capacity of the vehicle. The mechanical flywheel energy storage alone can support an electric vehicle to travel hundreds of kilometers. When mechanically charging, the mechanical charging shaft of the charging pile is mechanically connected to the external port of the mechanical charging shaft of the electric vehicle. The mechanical charging shaft of the electric vehicle can be mechanically connected to the motor shaft (one end of which is directly connected to the transmission input shaft 1), at this time, the transmission should be placed in neutral, and the mechanical charging shaft of the electric vehicle can also be mechanically connected to the movable friction wheel 4 of the transmission. At this time, the external spline sleeve 42 on the movable friction wheel 4 should be in the position of the empty groove 62 formed in the output gear 6 to cut off the connection between the output end of the transmission and the driving wheel.

Furthermore, the present invention can also constitute a mechanically directly driven flywheel energy storage vehicle. Using the transmission of the present invention, its flywheel energy storage capacity can meet the designed cruising range. For example, if the mass of the above-mentioned limit plate and small flywheel 134 is increased to 500 kilograms, and the energy storage in the form of a mechanical flywheel is increased to 300 megajoules, the inside of the transmission can be vacuum; correspondingly, the installed capacity of the battery-motor system is significantly reduced to a level one order of magnitude smaller than that of current electric vehicles. For example, if the battery capacity is only 10 Kwh, and the motor power is reduced to 10 Kw, it can be only used for self-charging of the vehicle, that is, the motor is used to charge the transmission flywheel system under garage power conditions, and to drive the vehicle in emergencies. Replacing current electric vehicles with mechanical direct drive flywheel energy storage vehicles can significantly reduce environmental pollution caused by huge amounts of used batteries.

For the mechanical flywheel-battery hybrid energy storage vehicle of the present invention, since the mechanical charging time of the roadside charging pile is very short, there is no time to complete the battery charging at the same time. Therefore, when the mechanical flywheel-battery hybrid energy storage vehicle of the present invention uses flywheel energy storage to drive, the electric motor should charge the battery pack in the generator state, charging the battery pack is slowly completed over a longer period of time. The technology used by the electric motor to charge the battery is a well-known technology for current electric vehicles. Therefore, the mechanical flywheel-battery hybrid energy storage vehicle of the present invention should have two sets of battery charging systems, the above-described system that uses flywheel energy storage to charge the battery pack, and a system that uses mains power to slowly charge the battery pack when parked, for example in the garage.

It is worth mentioning that while the above-mentioned charging system in the garage charges the battery, the electric motor also mechanically charges the above-mentioned flywheel system of the vehicle over a relatively long period of time. That is, the motor slowly increases the speed of the input rotation system of the transmission of the present invention until it reaches the rated speed that is full of mechanical flywheel energy.

### Example 6

This example uses the mechanical flywheel-battery hybrid energy storage vehicle with a mechanical charging system described in Example 5. Here, the mechanical charging shaft of the charging pile is mechanically connected to the mechanical charging shaft of the electric vehicle through an external port, the mechanical charging shaft of the electric vehicle is mechanically connected to the movable friction wheel 4 of the transmission. When mechanically charged, the transmission is in a reverse drive state of driving the input end from the output end, that is, the state of the transmission when the vehicle is decelerating and braking, the transmission ratio of the transmission increases from small to large under the control of the controller, so that the mechanical charging shaft of the charging pile can drive the input shaft 1 of the transmission at a lower speed to the high speed required for mechanical flywheel energy storage. When the charging pile is charged with 3000NM torque at 8000 rpm, it only takes about 85 seconds to fill the above 200MJ mechanical energy storage. After the charging pile is charged, the electric vehicle should drive a sufficient mileage with flywheel energy storage. After the flywheel energy storage is basically used up, it can then be connected to the battery-motor drive, which can greatly increase the cruising range of the electric vehicle.

### Example 7

This example uses the charging pile for charging flywheel energy storage-battery energy storage hybrid electric vehicle as described in Example 5. In the charging pile, a motor-driven energy storage transmission of the present invention in included to change the rotation speed of the mechanical charging shaft by changing the transmission ratio during charging. Under normal circumstances, the transmission ratio is changed from large to small, so that the rotation speed of the mechanical charging shaft changes from low to high to achieve the best charging effect. The flywheel energy storage system of the energy storage transmission of the present invention in the charging pile releases energy when charging to the outside, and drives the motor to store energy in the flywheel system during the idle time when the energy is not charged. When the energy storage transmission of the present invention is installed in the charging pile, it is suitable for charging the flywheel energy storage-battery energy storage hybrid electric vehicle in which the mechanical charging shaft in the vehicle is mechanically connected to the motor shaft.

### Example 8

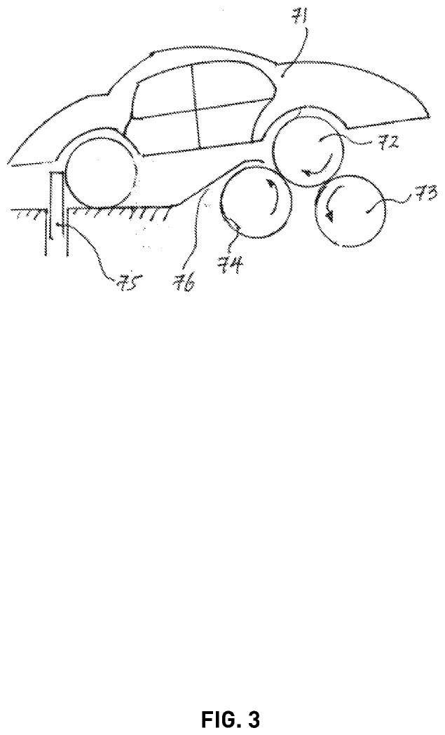

This example uses the charging pile equipped with the energy storage transmission of the present invention described in Example 7. As shown in FIG. 3, there is also a pair of ground rollers 73 and 74 that are turned as shown by the arrows in FIG. 3 and whose peripheral linear speeds are maintained in the same direction and speed, at least one of the rollers is driven by the energy storage transmission of the present invention driven by the above-mentioned electric motor installed in the charging pile. When two rollers are driven simultaneously, the transmission output gear 6 can be driven to mesh with two external gears of the same size that are coaxially fixed with the drums 73 and 74 respectively, so that the drums 73 and 74 can rotate at the same speed and in the same direction. When charging, the driving wheel 72 (here, the front wheel) of the charged flywheel energy storage-battery energy storage hybrid electric vehicle 71 is supported on the rollers 73 and 74, the rollers 73 and 74 drive the driving wheels 72 to rotate, and reversely drive the input shaft 1 through the vehicle's drive train and the transmission of the present invention to the high speed required for energy storage. 76 is a support plate, used for the charged vehicle to drive up and place the driving wheel between the rollers. When the vehicle drives in and exits after charging, the roller is braked. 75 is a baffle, which rises from the ground slot to block the non-driving wheels when the vehicle is charged, it prevents the vehicle from moving while charging and will return to the ground slot when charging ends. If stopper 75 is not used, the parking brake of the vehicle being charged should be set on the non-driven wheels.

### Example 9

The present invention, combined with an electric motor, can constitute a new type of soft-start energy-storage speed-regulating motor. At this time, the input shaft 1 is directly connected to the motor shaft. When the motor starts with load, the centrifugal force is gradually established because the rotation speed is gradually increased, the transmission torque also gradually increases, so even if it is started with full load, the starting current of the motor is very small, similar to that of no-load starting. The variable speed function of the present invention can constitute a wide range of speed regulation capabilities of the motor. When the load is small, the transmission ratio will be changed to adapt to the load to reduce power consumption. It has significant energy-saving effects for loads such as fans and water pumps. Moreover, the performance and energy-saving effect of the speed-regulating motor of the present invention are better than those of the frequency converter speed regulation, because the frequency converter speed regulation cannot increase the output torque at low speed, while the present invention can do this. The cost of the transmission of the present invention is not higher than that of a frequency converter with the same power, so it can replace the frequency converter. The speed-regulating motor of the present invention can also have an energy storage operation function, which stores energy when the load is light and releases kinetic energy when load peaks and impact loads arrive. It plays the role of balancing operation and protecting the power grid from impact when the load changes drastically. The energy storage speed regulating motor of the present invention can use ordinary and cheap squirrel cage asynchronous motors for the motor part. The comparable cost of the whole machine is lower than that of various current types of motors with soft starters and speed-adjustable motors, with significant advantages in performance-price ratio.

### Example 10

The aforementioned method of providing a transmission with an energy storage function according to the present invention can use the gear pump/motor described in the inventor's U.S. Pat. Nos. 487,253, 4,932,504, and 5,161,961; the energy storage function of the transmission is completed by the hydraulic energy storage mechanism. For example, using a hydraulic-air bag accumulator, the output gear 6 is mechanically connected to the continuously variable gear pump/motor through the energy storage side clutch, the hydraulic port of the continuously variable gear pump/motor is connected to the hydraulic air bag accumulator and liquid storage tank through the reversible hydraulic valve, the output gear 6 is also directly connected to the electric motor or connected to the internal combustion engine through a conventional transmission. When the vehicle decelerates and brakes, the output gear 6 drives the continuously variable gear pump/motor through the clutch; after the hydraulic valve is connected, high-pressure oil is injected into the hydraulic airbag accumulator to increase the pressure and compress the airbag to store energy, converting vehicle kinetic energy into hydraulic potential energy, and at the same time, obtaining braking torque for the vehicle. When the vehicle stops at red light, the hydraulic valve closes and the continuously variable gear pump/motor becomes the parking brake because the fluid is incompressible; when the light turns green and the vehicle starts to accelerate again, the hydraulic airbag accumulator releases the stored energy and the pressure decreases accordingly, the reversible hydraulic valve is switched to the reverse direction, so that the direction of the gear motor that should be reversed is still the same as that of the gear pump during operation, thus starting and accelerating the vehicle through the output gear 6. When the hydraulic air bag accumulator is released and the energy storage is completed, and the electric motor or internal combustion engine relay drives, the energy storage side clutch is disengaged, the electric motor of the electric vehicle relay drives the vehicle, or the transmission of the internal combustion engine vehicle is engaged, the vehicle is driven by internal combustion engines. When the above-mentioned continuously variable gear pump/motor is a continuously variable volume displacement hydraulic pump/hydraulic motor invented by the present inventor, it can change the displacement per revolution smoothly and continuously, which is equivalent to the smooth and stepless change of the transmission ratio of the transmission, so the best acceleration curve and best braking ability can be obtained.

### Example 11

In the method for providing energy storage function to transmission as described in Example 10, wherein the above-mentioned continuously variable gear pump/motor uses the movable radial sealing block invented by the inventor to continuously change the flow rate, that is, when there is a pump effect clutch, when the vehicle starts working in gear motor mode, when the movable radial sealing block is controlled to move smoothly from the completely disengaged non-radial sealing position to the fully sealed position, the motor effect reaches the maximum from none, allowing the vehicle to obtain the best starting acceleration capability. When the vehicle decelerates and brakes, the movable radial sealing block is controlled to move smoothly from the completely disengaged non-radial sealing position to the fully sealed position, and the pump effect reaches the maximum from no radial sealing at all, allowing the vehicle to obtain the required deceleration or optimal braking capability.

### Example 12

The method for allowing a transmission to have an energy storage function as described in Example 11, wherein a pair of gears constituting a gear pump/motor is composed of the output gear 6 and the driven gear 64, at this time, the gear pair is in the liquid-tight sealing side plates on both sides. When the vehicle is running normally, the reversible hydraulic valve is closed, the movable radial sealing block is in the completely disengaged position, the pump effect is zero, and the gear pair is idling in the oil, so the loss is very small.

What is claimed is:

1. A method of mechanically storing energy and saving energy in a transmission, comprising:
a) when the transmission is in working condition, mechanically storing the kinetic energy in the transmission when changing speed while simultaneously obtaining braking torque; and
b) when the transmission is in acceleration, releasing stored kinetic energy simultaneously while changing speed,
thus achieving energy storage and saving in the transmission.

2. The method of claim 1, wherein the transmission comprises at least two planetary friction wheels 31 evenly distributed around the axis of the input shaft 1 and with varying outer diameters, wherein its two ends are supported in the slide grooves of the planet carriers 13 and 14 through planetary bearings and slider bearing seats 133 and 143 that can slide in the slide grooves of the planet carrier;
wherein its axis is parallel or non-parallel to the axis of input shaft 1;
wherein the planetary friction wheel 31 can rely on the centrifugal force generated when the input shaft 1 rotates to move along the radial direction of the input shaft 1, thereby contacting and rubbing with the fixed friction wheel 2 and the rotatable friction wheel 4, obtaining power output on the rotatable friction wheel 4;
wherein axial movement of the fixed friction wheel 2 and/or the rotatable friction wheel 4 can change the planetary friction wheel contact radius R1 and/or R3, thereby changing the gear ratio of the transmission;
wherein the rotatable friction wheel 4 at the output end reversely drives the input shaft 1 at the input end to obtain braking torque, and at the same time increases the rotation speed of the input rotation system including the limit plate and small flywheel 134, thus storing the kinetic energy in the revolution of the input rotation system and the rotation of the planetary friction wheel 31;
wherein under the acceleration mode of the transmission, the fixed friction wheel 2 and/or the rotatable friction wheel 4 are moved axially to change the transmission ratio from large to small, thus using the kinetic energy stored in the input rotation system for output.

3. An energy-storage transmission, comprising at least two planetary friction wheels 31 evenly distributed around the axis of the input shaft 1 and with varying outer diameters, wherein its two ends are supported in the slide grooves of the planet carriers 13 and 14 through the planet bearings and slider bearing seats 133 and 143;
wherein its axis is parallel or non-parallel to the axis of input shaft 1;
wherein the planetary friction wheel 31 can rely on the centrifugal force generated when the input shaft 1 rotates to move along the radial direction of the input shaft 1, thereby contacting and rubbing with the fixed friction wheel 2 and the rotatable friction wheel 4, obtaining power output on the rotatable friction wheel 4;
wherein the distance from the contact point of the planetary friction wheel 31 and the fixed friction wheel 2 to the axis of the planetary friction wheel is the contact radius R1, and the distance from the contact point to the axis of the input shaft 1 is the fixed friction wheel contact radius R2;
wherein the distance from the contact point of the planetary friction wheel 31 and the rotatable friction wheel 4 to the axis of the planetary friction wheel is the contact radius R3, and the distance from the contact point to the axis of the input shaft 1 is the contact radius R4 of the rotatable friction wheel;
wherein transmission ratio I=input shaft speed/rotatable friction wheel speed=1/(1−R2R3/(R1R4));
wherein then the transmission ratio is negative, the transmission is in reverse gear, axial movement of the fixed friction wheel 2 and/or the rotatable friction wheel 4 can change the planetary friction wheel contact radius R1 and/or R3, thereby continuously changing the transmission ratio of the transmission;
wherein the rotatable friction wheel 4 at the output end obtains braking torque when counter-driving the input shaft 1 at the input end, and at the same time increases the rotation speed of the input rotation system including the limit plate and small flywheel 134, thereby storing kinetic energy in the revolution of the input rotation system and the rotation of the planetary friction wheel 31;
wherein in the acceleration mode of the transmission, the fixed friction wheel 2 and/or the rotatable friction wheel 4 are axially moved, changing the transmission ratio from large to small, thereby using the kinetic energy stored in the input rotation system for output acceleration.

4. The energy-storage transmission of claim 3, wherein a radial chute is provided in the planet carrier, and the radial chute is equipped with slide block bearing seats 133 and 143 that can slide in the radial chute along the radial direction; wherein the inner cylindrical surface of the slider bearing seat is equipped with outer cylindrical bearing sleeves 131 and 141 that can rotate within it, and the outer cylindrical bearing sleeve is equipped with planetary bearings that are ribless cylindrical roller bearings or other types of bearings that allow axial slip, thereby preventing the axial component of the contact force on the planetary friction wheel from passing through the planetary bearing, so that the planetary friction wheel is constrained in the radial and axial directions by contact with the fixed friction wheel 2 and the rotatable friction wheel 4 under variable speed conditions;
wherein the planet carrier, slider bearing seat, outer cylindrical bearing sleeve, ribless planetary bearing and planetary friction wheel constitute a subsystem; wherein multiple such subsystems are uniformly distributed around the input shaft axis, wherein each subsystem is consistent in size and weight to obtain equal centrifugal force and automatic load sharing.

5. The energy-storage transmission of claim 3, wherein the rotatable friction wheel 4 and the fixed friction wheel 2 are made into smooth concave envelope curved surfaces near the contact points between the convex planetary friction wheel 31 and the rotatable friction wheel 4 and the fixed friction wheel 2;
wherein the absolute value of its curvature in each direction is slightly smaller than the absolute value of the curvature near the contact point of the corresponding planetary friction wheel 31, thereby obtaining an inner contact with a smaller difference in curvature in each direction of the planetary friction wheel;
wherein when the shape of the planetary friction wheel 31 is concave, the curved surfaces of the rotatable friction wheel 4 and the fixed friction wheel 2 near the contact point are convex, wherein the absolute value of the curvature in each direction is slightly larger than the absolute value of the corresponding curvature of the planetary friction wheel to obtain a smaller internal contact curvature difference between the concave and convex mating surfaces, thereby improving contact strength and transmission efficiency;
optionally wherein the friction pair can be made of high contact strength materials such as cermet materials and carbon fiber reinforced ceramics materials that improve friction wheel contact strength.

6. The energy-storage transmission of claim 3, wherein the planetary friction wheel 31 has a neutral groove C30, so that when the fixed friction wheel 2 is pushed to the position corresponding to the groove, it cooperates with the limit baffles 134 and 144 to limit the floating of the slider bearing seat, allowing the fixed friction wheel 2 to disengage from the planetary friction wheel 31, and the transmission is in neutral; wherein the neutral slot avoids the contact position where the transmission ratio tends to infinity; wherein the rotatable friction wheel 4 can move axially so that it is out of contact with the planetary friction wheel 31 and forms a neutral position.

7. The energy-storage transmission of claim 3, comprising an output gear 6 that can slide along the axial direction, wherein an inner cone 65 is coaxially formed in the output gear 6 such that when the gear is directly shifted, the outer cone 15 is coaxially formed at the end of the input shaft 1 and engages in a conical manner; wherein the output gear 6 and a passive output gear 64 are a pair of helical gear meshing pairs with a helical angle;
wherein the direction of the meshing axial force of the helical gear pair points to pushing the output gear 6 toward the input end, making the inner cone 65 and the outer cone 15 compress such that the friction torque obtained is always greater than the transmitted torque;
wherein during decelerating and braking, the rotation speed of the passive output gear 64 exceeds the output gear 6 to drive the output gear 6, the direction of the meshing axial force of the output gear 6 is reversed, the output gear 6 is pulled away from the outer cone 15 in the axial direction, the direct gear is automatically disengaged, and the output end of the rotatable friction wheel 4 is disengaged from the output gear 6;
wherein when reducing the internal combustion engine throttle or the speed of the electric motor such that the input speed of the transmission is lower than the output speed and the meshing axial force of the output gear pair 6 and 64 pulls the inner cone 65 away from the outer cone 15, the output gear 6 is in a neutral position with the external spline sleeve 42 facing the empty slot 62 and is conducive to vehicle sliding;
wherein when the outer cone 15 is separated from the inner vertebra 65, and the output end of the rotatable friction wheel 4 is engaged with the output gear 6, the transmission is in a shifting condition with a transmission ratio greater than 1, when the output end of the rotatable friction wheel 4 is also disengaged from the output gear 6, the transmission is in neutral.

8. The energy-storage transmission of claim 3, wherein the transmission is used in electric vehicles, and the starting acceleration process mainly relies on the energy storage release of the transmission energy storage rotation system of the present invention, wherein the battery loading capacity is significantly reduced compared to the current level, and the supply voltage is increased to reduce the discharge current, wherein the electric vehicle uses commutator-less DC motors to eliminate the inverter link from DC to AC and the variable frequency speed regulation link, reducing the cost of the vehicle.

9. The energy-storage transmission of claim 3, wherein the transmission is used for internal combustion engine vehicles, and the transmission input shaft 1 is directly connected to the crankshaft of the internal combustion engine; wherein the input rotation system of the transmission functions as a flywheel in an internal combustion engine and a separate flywheel is omitted; wherein the transmission releases stored energy to drive to provide several times the acceleration power of the engine in a few seconds; wherein the reserve power of the engine is reduced or eliminated.

10. The energy-storage transmission of claim 8, wherein the transmission provides braking torque during deceleration, which is equivalent to a frictionless brake, allowing the traditional friction brake to be simplified, reducing the cost of the braking system and improving braking reliability.

11. The energy-storage transmission of claim 3, wherein the transmission is driven by an electric motor and changes the gear ratio of the transmission to give a wide output speed range from deceleration to acceleration, wherein the transmission replaces frequency converters and motor soft starters; wherein the flywheel energy storage function of the transmission is controlled by the controller to store energy at low loads and release energy at peak loads, thereby flattening the peaks and troughs caused by short-term load changes, avoiding harmonic damage and energy consumption of the frequency converter, and protecting the power grid.

12. The energy-storage transmission of claim 11, wherein the planetary friction wheel is made into a stepped cylindrical friction wheel, and the cylindrical diameters of each step are different; wherein the axis of the planetary friction wheel is parallel to the axis of the input shaft 1; wherein the fixed friction wheel and the rotatable friction wheel are made into cylindrical shapes to make the contact between the planetary friction wheel, the fixed friction wheel and the rotatable friction wheel be line contact; wherein the axial sliding fixed friction wheel and/or the rotatable friction wheel can change the diameter of the stepped cylinder in contact between the planetary friction wheel and the fixed friction wheel and/or the rotatable friction wheel, thereby changing the gear ratio of the transmission step by step.

13. The energy-storage transmission of claim 12, wherein the transmission is simplified to a very small ratio gear reducer, the motor is a 4-pole asynchronous motor, the reduction ratios of gear reduction are 1.5, 2, 3, and 4 respectively, replacing 6-pole, 8-pole, 12-pole and 16-pole motors respectively, wherein the efficiency loss of the gear reducer is less than the efficiency loss increased by increasing the number of poles of the original AC motor to achieve the same output torque; wherein the added weight of the gear reducer is less than the weight added by increasing the number of poles of the motor, wherein energy efficiency is improved and the use of non-ferrous metals in the motor is reduced.

14. The energy-storage transmission of claim 3, wherein the transmission is used in wind turbines and the transmission is driven by the wind turbine through gear transmission;
wherein when it works in the speed-increasing condition, the input shaft 1 of the transmission is connected to the generator;
wherein when the wind turbine speed changes due to wind changes, the transmission is controlled to continuously and accurately change the speed-up ratio, so that the mechanical speed obtained by the generator accurately meets the same voltage, same frequency and same phase requirements of the wind turbine connected to the power grid;
wherein the transmission absorbs and stores energy when the wind is strong and releases energy when the wind is weak;
wherein when coupled with transmission ratio control, the transmission replaces the current wind power grid-connected high-power power regulation system;
wherein the transmission can completely eliminate the harmonic damage caused by the frequency converter inverter to the power grid;
wherein when the wind speed is very low, the speed increase ratio of the transmission is increased so that the generator can still generate electricity and improve the utilization rate of wind energy.

15. The energy-storage transmission of claim 3, wherein the transmission is used to form a mechanical flywheel-battery hybrid energy storage vehicle with a mechanical charging system; optionally wherein carbon fiber winding is used to strengthen the limiting plate and small flywheel 134; optionally wherein the mass of the flywheel is increased;
wherein the flywheel energy storage includes the revolution energy storage of the entire input rotation system, the rotation energy storage of the planetary friction wheel 31 and the rotation energy storage of the motor rotor;
wherein when mechanically charging, the mechanical charging shaft of the charging pile installed on the roadside is mechanically connected to the external port of the mechanical charging shaft of the vehicle; wherein the roadside charging pile/charging pile uses mechanical direct drive to complete the mechanical charging of the vehicle in a short time of tens of seconds to minutes;
wherein during a longer period of time when the vehicle is traveling using flywheel energy storage, the electric motor can charge the battery pack in generator mode;
optionally wherein the mechanical flywheel-battery hybrid energy storage vehicle has a system that uses mains power to slowly charge the battery pack in the garage;
wherein the electric motor can also mechanically charge the above-mentioned flywheel system of the vehicle for a long period of time at the same time, that is, the electric motor can slowly increase the speed of the transmission input rotation system through the electric motor, until it reaches the rated speed full of mechanical flywheel energy.

16. A mechanical flywheel-battery hybrid energy storage vehicle that uses the energy-storage transmission of claim 15, wherein when mechanically charging, the mechanical charging shaft of the vehicle is mechanically connected to the motor shaft or to the movable friction wheel 4 of the transmission, and the transmission is placed in neutral.

17. A roadside charging pile comprising the energy-storage transmission of claim 15 for mechanically charging a mechanical flywheel-battery hybrid energy storage vehicle, wherein the energy-storage transmission is driven by a motor and is installed in the charging pile to change the rotation speed of the mechanical charging shaft by changing the transmission ratio during charging; wherein the transmission ratio is changed from large to small, so that the rotation speed of the mechanical charging shaft changes from low to high; wherein the flywheel energy storage system of the energy storage transmission in the charging pile releases energy when charging externally, and drives the motor to store energy in the flywheel system during the idle time when it is not charging.

18. A roadside charging pile comprising the energy-storage transmission of claim 15 for mechanically charging a mechanical flywheel-battery hybrid energy storage vehicle, wherein the charging pile is equipped with a pair of ground rollers 73 and 74, whose peripheral linear speeds remain in the same direction and speed, and at least one of the rollers is driven by the energy storage transmission of the present invention driven by an electric motor installed in the charging pile;
wherein when driving two rollers at the same time, the transmission output gear 6 can be meshed with two external gears of the same size that are coaxially connected to the rollers 73 and 74 respectively, so that the rollers 73 and 74 can rotate at the same speed and in the same direction;
wherein when charging, the driving wheel 72 of the charged flywheel energy storage-battery energy storage hybrid electric vehicle 71 is supported on the rollers 73 and 74, the rollers 73 and 74 drive the driving wheels 72 to rotate and reversely drive the input shaft 1 through the vehicle's drive train and the transmission of the present invention until the high speed required for energy storage.

19. The method of claim 1, wherein the transmission comprises a continuously variable displacement hydraulic pump/motor, wherein the energy storage function of the transmission is completed by a hydraulic energy storage mechanism, optionally wherein the hydraulic energy storage mechanism is a hydraulic-air bag accumulator;
wherein the output gear 6 is mechanically connected to the continuously variable pump/motor through the energy storage side clutch and is also directly connected to the electric motor or connected to the internal combustion engine through a conventional transmission;
wherein the hydraulic port of the continuously variable pump/motor is connected to the hydraulic airbag accumulator and liquid storage tank through the reversible hydraulic valve;
wherein when the vehicle decelerates or brakes, the output gear 6 drives the continuously variable pump/motor through the clutch, and through the connected hydraulic valve, high-pressure oil is injected into the hydraulic airbag accumulator to store energy, thus converting vehicle kinetic energy into hydraulic potential energy and simultaneously obtaining braking torque;
wherein when the vehicle stops, the hydraulic valve closes and the continuously variable pump/motor becomes the parking brake;
wherein when the vehicle starts to accelerate again, the hydraulic airbag accumulator releases the stored energy and the pressure decreases, and the reversible hydraulic valve is switched to the reverse direction so that the rotate direction of the gear motor that should be reversed is still the same as that of the gear pump during operation, thereby starting and accelerating the vehicle through the output gear 6;
wherein when the hydraulic air bag accumulator is released, energy storage is complete, and the electric motor or internal combustion engine relay drives, the energy storage side clutch disengages, the electric motor of an electric vehicle relays the vehicle, or the transmission of an internal combustion engine vehicle engages and the internal combustion engine drives the vehicle.

20. The method of claim 19, wherein the transmission comprises a movable radial sealing block to continuously change the flow rate of the gear pump or gear motor such that it has a pump effect clutch; wherein when the vehicle starts working in motor mode, when the movable radial sealing block is controlled to move smoothly from the completely disengaged non-radial sealing position to the fully sealed position, the motor effect reaches the maximum from zero, allowing the vehicle to obtain the best starting acceleration capability; wherein when the vehicle decelerates and brakes, the movable radial sealing block is controlled to move smoothly from the completely disengaged non-radial sealing position to the fully sealed position, and the pump effect reaches the maximum from zero, allowing the vehicle to obtain the required deceleration or optimal braking ability;
optionally wherein the pair of gears that constitute the gear pump/motor are composed of the output gear 6 and the driven gear 64. where said gear pair is in the liquid-tight scaling side plates on both sides.
